(19) United States
(12) Patent Application Publication
(10) Pub. No.: US 2009/0159067 A1
(43) Pub. Date: Jun. 25, 2009

(54) Receiver hitch mounted cooking unit and method of using same

(76) Inventor: Robert L. Croft, Hunt, TX (US)

Correspondence Address: THE MATTHEWS FIRM, 2000 BERING DRIVE, SUITE 700, HOUSTON, TX, 77057, US

(21) Appl. No.: 12/005,024

(22) Filed: Dec. 21, 2007

(51) Int. Cl. A47J 37/07; F24C 1/16

(52) U.S. Cl. 126/25 R; 99/449; 126/9 R; 99/357

(57) ABSTRACT

An apparatus that is selectively attachable to a vehicle, for transporting a cooking device and positioning the cooking device so as to also permit access to the vehicle. The apparatus includes a hitch insertion member for insertion into a trailer hitch, and a mounting support for a cooking device, for example a barbeque pit. The cooking device has a slidable cover that allows access to the interior of the device to allow cooking or heating. The slidable cover allows access without interfering with the vehicle.

### TECHNICAL FIELD

The present invention relates to mobile hitch mounted cooking and/or smoking apparatuses. More specifically the present invention relates to a hitch mounted cooking devise, which may be used while attached to the vehicle or may be detached for use away from the vehicle.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers.

FIG. 1 illustrates a front elevated view partially in cross section of an embodiment of the cooking apparatus in accordance with the present invention;

FIG. 1A illustrates a side, elevated view, partially in cross section of the apparatus in FIG. 1 in accordance with the present invention;

FIG. 2 illustrates a top view of an embodiment in accordance with the present invention; and

FIG. 3 illustrates a front elevated view, partially in cross section, of another embodiment of the cooking apparatus in accordance to the present invention.

### DETAILED DESCRIPTION OF EMBODIMENTS OF THE INVENTION

Outdoor leisure and recreational activities such as hunting, camping, fishing, picnicking at the beach or a park, cookouts, road trips, and tailgate parties at sporting events have become increasingly popular. Often, people are transported to these types of outdoor activities in a vehicle such as a truck, pickup truck, sport utility vehicle, or recreational vehicle. Frequently, people partaking in these mobile outdoor activities desire a freshly cooked hot meal.

One way of cooking a hot meal is to build a campfire and cook the meal over the fire. However, building a campfire can require a lot of effort, and creates a risk of fires. Also, campfires are not permitted in many areas. Hot meals can also be cooked on a public barbeque pit at a campground or picnic area. However, public barbeques pits are frequently dirty, are in a state of disrepair, or are not available (particularly in remote or semi-remote hunting areas).

Another way of cooking a hot meal is to bring a barbeque pit in the vehicle, set it up at the hunting, camping, picnicking, or tailgating site, and cook the meal on the barbeque pit. However, transporting the barbeque pit in the vehicle uses valuable space inside the vehicle, and further, the barbeque pit cannot be put back into the vehicle until it cools down after cooking.

Another approach has been to permanently attach a barbeque pit to the exterior of a vehicle. However, it is often undesirable to always have a barbeque pit attached to the exterior of the vehicle. For example, there is a risk of theft, the barbeque pit is exposed to the elements for a long period of time, and parking can be problematic.

Yet another approach is to attach a barbeque pit to a trailer hitch on the rear of the vehicle. Although this has the advantage of permitting removal of the barbeque from the vehicle, this approach has the disadvantage of blocking access to the rear doors or hatch of the vehicle when the barbeque is attached. Further, if the barbeque pit is large, there may be problems easily removing the barbeque pit. Still further, most conventional hinged barbeque pit lids would be hampered by the vehicle when attempting to open or close the lid. In summary, all of the known ways of cooking a hot meal when partaking in mobile outdoor activities have proven inadequate.

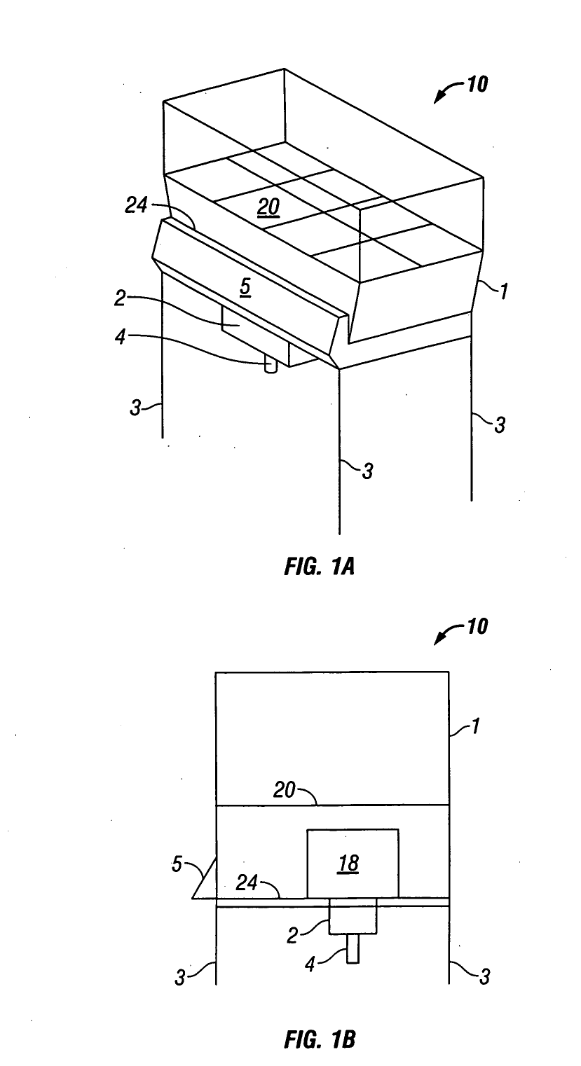

FIG. 1 illustrates the hitch mounted cooking unit 10. The cooking unit 10 is preferably a substantially rectangular shaped box and may be made of a variety of materials. Preferably the cooking unit 10 is of a welded steel construction. It should be appreciated, by all, that the cooking unit 10 could get extremely hot during operation and therefore there are some construction material limitations in that the materials must be sufficiently heat resistant to maintain the integrity of the structure during use, after cooking, as well as, during exposure to normal atmospheric or other weather related elements. However, it should be equally appreciated that the exact shape of the cooking unit 10 as well as the exact materials of the cooking unit 10 should not be construed of a limitation herein. Further, the construction of the cooking unit 10 should not be construed as being limited to welding as it is well known in component construction that a variety of methods including, but not limited to, brazing, screwing, bolting, riveting, and similar methods may be used in construction of cooking unit 10. Preferably the underside of cooking unit 10 is adapted with a mounting bracket 2. Preferably mounting bracket 2 is attached to the cooking unit 10 in a central lower location in order to provide adequate balance and support to the cooking unit 10 during transportation and/or use. It should be understood, by those in the art, that a variety and types of mounting brackets 2 can be placed on the cooking unit 10 and the exact location of the mounting bracket 2 may vary depending on the exact type of support that the mounting provides or the support structure that is provided with a mounting; therefore, the exact location of mounting should not be a limitation herein. Preferably, mounting bracket 2 further comprises a mounting system 4, which may be attached to conventional hitch receivers which are typically, but not necessarily, at the front and/or rear of vehicles, trailers, and such. The mounting system 4 maybe of many conventional designs depending on factors such as, but not limited to, the height of the hitch above the ground, the position of the hitch relative to the vehicle or trailer and similar conditions. Mounting bracket 2 as well as the receiver mounting system 4 may be integral or may be more then one piece. They may also be attached by a variety of methods together or to the cooking unit 10 such as, but not limited to, welding, bolting, riveting, screwing, sliding parts, pins, and similar methods. It should be appreciated that although typically a square hitch is one of the more popular conventional methods of attaching units to a rear assembly of a vehicle, the mounting bracket to a mounting system 4 can also be adapted to trailer ball hitches and other hitch receivers of a variety of cross sectional shapes and sizes.

Cooking unit 10 further comprises an outer shell or box 1 and an inner floor 24 wherein the inner floor 24 may be used for coal, wood, or other fuel sources. Cooking unit 10 may further comprise a shelf 5 or other support/temporary storage area at the front of the box 1. The shelf 5 may be only at the front of the box 1, may wrap around the box 1, may be on the sides of box 1, or any combination thereof. Preferably cooking unit 10 also includes one or more grated surfaces 20 which can be used for the placement of food or other items to be cooked in the cooking unit 10. Preferably cooking unit 10 will also have detachable legs 3, such detachable legs should be adapted to easily fit in the corners of cooking unit 10. It should be understood that although the preferred number of legs 3 is four, there could be a variety of combinations such as but not limited to tri pods, center-stands, scissor-stands, or a variety of conventional means for supporting the cooking unit 10 should it be removed from the hitch and used away from the vehicle. It should be further understood that the legs 3 can also be telescoping legs or folding legs. Such designed legs or supports 3, if more permanently attached to the cooking unit 10, would reduce the risk of losing or misplacing the legs. Further, telescoping legs could also be used in conjunction with a small racheting or jacking unit to allow the legs or supports 3 to support and slightly lift the cooking unit 10 to allow easy removal and/or replacement onto the hitch.

FIG. 1A illustrates a side view of an embodiment of the cooking unit 10. Preferably cooking unit 10 has a side door 18 which may be used to insert fuel such as, but not limited to, coal or wood for cooking within the unit. Door 18 may be of a variety of sizes and may be large enough to only open between a grated area 20 and the cooking unit floor 24 or it may encompass the entire side of the cooking unit 10 in order to be easily move or adjust grates, fuel placement, mixing of the fuel, and a variety of other circumstances. It should be appreciated that door 18 can be positioned almost anywhere within the cooking unit 10 including any side, more than one side or may not be included at all and as such the positioning or inclusion or not inclusion of door 18 should not be a limitation herein.

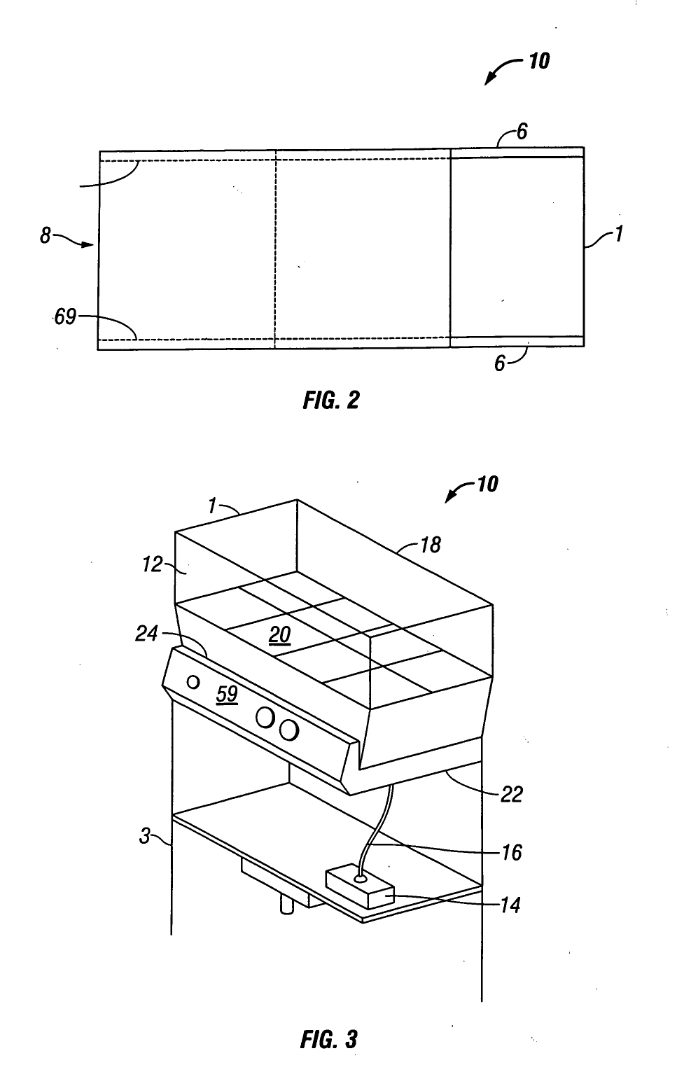

FIG. 2 illustrates a top view of an embodiment of the present invention. In this embodiment the cooking unit 10 further comprises a sliding lid 8. It should be appreciated that sliding lid 8 is extremely beneficial when the cooking unit is being used while still attached to the vehicle in such a case the sliding lid 8 will be able to be removed or attached without any obstructions from the vehicle or trailer towards the cooking unit. It should be further appreciated that such a sliding cover with the attaching lids will also improve the security of the cover when the vehicle is being transported. Preferably cooking unit 10 is formed so as to have a lip 6 on at least two opposing sides of the cooking unit 10. The lip 6 preferably extends an entire length of the cooking unit 10 but may also only extend partially, be interrupted, or be a series of smaller lips. Lid 8 is preferably constructed so as to have a receiving section 6a on two opposing sides of the lid 8 wherein the receiving section 6a and the lip section 6 can be made so as to slide the lid 8 on or off cooking unit 10. It should be appreciated that lid 8 can be used in conjunction with door 18 or embodiments may be of a variety of embodiments made available using either lid 8 or door 18 or a combination thereof. It should be further appreciated that other top doors or lids are also envisioned. Still further, it should be understood that lip section 6 and receiving section 6a can be interchanged (i.e. lip 6 could be part of the lid 8 while the receiving section 6a is formed on the walls of the cooking unit 10). Such doors may be hinged on the side so as to open without striking or contacting the vehicle.

FIG. 3 illustrates a front view of another embodiment of the present invention. In this embodiment another fuel source such as, but not limited to, propane is used for the cooking operation. The propane may be stored in a conventional cylinder 14 or may be provided from an outside line after a vehicle is parked. As is typical in conventional propane powered cooking units a hose 16 extends from the propane bottle 14 into the cooking surface 22 of the cooking unit 10. In this embodiment, the shelf or storage rack 5a may also comprise controls for the fuel entering the cooking apparatus as well as possibly an ignitor switch. It should be appreciated that such controls and/or igniters are typically well known in the art and as such are not described in further detail herein. Preferably at least one or more grates 20 are located or positioned within box 1 to provide adequate cooking surfaces. The propane tank 14 may be stored in area 12, located beneath the flame source 22. It could also be included in a separate compartment next to or near the cooking unit 10 (not shown) or located in any other appropriate position. It should be appreciated vehicles which operate on propane or fuels other than gasoline, may allow the cooking unit 10 to be operated with the same fuels or may utilize any other available fuel source. This embodiment is also envisioned to have detachable legs 3 or extendable telescoping legs, which allow the cooking unit 10 to be used away from the vehicle.

It will be understood that certain features and sub-combinations are of utility and may be employed without reference to other features and sub-combinations. This is contemplated by and is within the scope of the claims. It may be seen from the preceding description that a novel portable hitch mounted cooking unit and method has been provided. Although specific examples may have been described and disclosed, the invention of the instant application is considered to comprise and is intended to comprise any equivalent structure and may be constructed in many different ways to function and operate in the general manner as explained hereinbefore. Accordingly, it is noted that the embodiments described herein in detail for exemplary purposes are of course subject to many different variations in structure, design, application and methodology. Because many varying and different embodiments maybe made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

I claim:

1. A cooking apparatus being attachable to a vehicle for transporting the apparatus and for use while attached comprising:
said cooking apparatus having walls and a bottom forming an enclosure therein;
said bottom further having and inside surface and an outside surface;
said walls further having a top side and a bottom side, said top side having a flange surface extending outwardly along at least two opposite walls;
a first floor surface defined by said inside surface of the cooking apparatus bottom;
at least one slidable cover defining a channel formed along at least two opposing edges of the cover, wherein said channel is configured to receive said flange surfaces of said walls so as to allow said cover to slidably cover or uncover said cooking apparatus;
a second floor surface, positioned above said first floor surface, said second floor surface defining apertures therein, wherein said second floor surface is for the placement of items to be cooked or heated;
a mounting unit attached to said outside surface of said cooking apparatus bottom; and
said mounting unit configured for mounting said cooking apparatus onto a vehicle, whereby said mounted cooking apparatus is prevented from contacting the ground.

2. The cooking apparatus of claim 1, further comprising a plurality of attachable legs for supporting said cooking apparatus when desired.

3. The cooking apparatus of claim 1, further comprising a plurality of telescoping legs for supporting said cooking unit when desired.

4. The cooking apparatus of claim 1, further comprising at least one hinged cover positioned so as to allow access to said first floor surface.

5. The cooking apparatus of claim 4, wherein said hinged cover is at least one door positioned on an exterior side of said cooking apparatus.

6. The cooking apparatus of claim 1, wherein said mounting unit is configured so as to attach to a square hitch receiver.

7. The cooking apparatus of claim 1, wherein said mounting unit is configured so as to attach to a trailer mounting system.

8. The cooking apparatus of claim 1, further comprising a fuel source for providing energy for cooking.

9. The cooking apparatus of claim 8, wherein said fuel source is a propane tank.

10. A method for using and transporting a portable cooking device comprising the steps of:
attaching a mounting unit to a bottom side of said cooking device, wherein said mounting unit is adaptable to attachment to a vehicle hitch receiver;
mounting said cooking device onto a receiving hitch of a vehicle, wherein said mounting prevents contact between the cooking device and the ground;
transporting said vehicle and cooking device to a desired location;
igniting a fuel source to provide cooking heat inside said cooking device; and
slidably removing a cover from the cooking device, said removal providing access into an interior of said cooking device.

11. The method of claim 10, further comprising the steps of:
attaching detachable legs to said cooking device; and
dismounting said unit from vehicle.

12. The method of claim 10, further comprising the steps of:
extending telescoping legs from said cooking device; and
dismounting said unit from vehicle.

13. The method of claim 10, wherein igniting a fuel source further comprises connecting a propane tank to said unit for cooking.

14. The method of claim 10, wherein igniting a fuel source further comprises placing a combustible material on the floor surface of said cooking device.

15. A cooking apparatus being attachable to a vehicle for transporting the cooking apparatus and for use while attached comprising:
said cooking apparatus having walls and a bottom forming an enclosure therein;
said bottom further having and inside surface and an outside surface;
said walls having a top side and a bottom side, said top side defining a channel formed along at least two opposing walls;
a first floor surface defined by said inside surface of the cooking apparatus bottom;
at least one slidable cover having a flange surface extending outwardly along at least two opposing edges, wherein said channel, formed along said top side of said wall, is configured to receive said flange surfaces of said slidable cover so as to allow said cover to slidably cover or uncover said cooking apparatus;
a second floor surface, positioned above said first floor surface, said second floor surface defining apertures therein, wherein said second floor surface is for the placement of items to be cooked or heated;
a mounting unit attached to said outside surface of said cooking apparatus bottom; and
said mounting unit configured for mounting said cooking apparatus onto a vehicle, whereby said mounted cooking apparatus is prevented from contacting the ground.

16. The cooking apparatus of claim 15, further comprising a plurality of attachable legs for supporting said cooking apparatus when desired.

17. The cooking apparatus of claim 15, further comprising a plurality of telescoping legs for supporting said cooking unit when detached from the vehicle.

18. The cooking apparatus of claim 15, wherein said mounting apparatus is an adaptor for a square hitch receiver.

19. The cooking apparatus of claim 1, further comprising a fuel source for providing energy for cooking.

20. The cooking apparatus of claim 19, wherein said fuel source is a propane tank.
